(19) United States
(12) Patent Application Publication
(10) Pub. No.: US 2016/0330030 A1
(43) Pub. Date: Nov. 10, 2016

(54) User Terminal For Detecting Forgery Of Application Program Based On Hash Value And Method Of Detecting Forgery Of Application Program Using The Same

(71) Applicant: SOONGSIL UNIVERSITY RESEARCH CONSORTIUM TECHNO-PARK, Seoul (KR)

(72) Inventors: Jeong-Hyun Yi, Seongnam-si (KR); Myeong-Ju Ji, Seoul (KR); Ji-Woong Bang, Incheon (KR); Tae-Joo Cho, Seoul (KR)

(73) Assignee: Soongsil University Research Consortium Techno-Park, Seoul (KR)

(21) Appl. No.: 15/109,235

(22) PCT Filed: Mar. 6, 2015
(86) PCT No.: PCT/KR2015/002200

§ 371 Date: Jun. 30, 2016

(30) Foreign Application Priority Data
Oct. 20, 2014 (KR) 10-2014-0141954
Jan. 8, 2015 (KR) 10-2015-0002936

(51) Int. Cl. H04L 9/32; G06F 21/52; G06F 21/12; H04L 29/06

(52) U.S. Cl. CPC H04L 9/3236; H04L 63/0876; G06F 21/52; G06F 21/12

(57) ABSTRACT

A user terminal for detecting forgery of an application program based on a hash value and a method of detecting forgery of an application program using the user terminal are disclosed. The user terminal includes a communication circuit, a hash value generation circuit and a forgery determination circuit. When the application program is executed, the communication circuit transmits information of the user terminal and the application program to an authentication server on a platform level to receive an original hash value of the application program from the authentication server, or to receive the original hash value from a peripheral device paired with the user terminal. The hash value generation circuit generates the hash value of the application program on the platform level. The forgery determination circuit compares the original hash value received from the authentication server or the peripheral device with the generated hash value on the platform level to determine whether the application program is tampered. Accordingly, the user terminal may be protected from a tampered application program. In addition, since forgery of the application program is detected on the platform level, it may overcome limitations of tamper detection technologies on an application program level that can be evaded by an attacker.

### THE ART TO WHICH THE INVENTIVE CONCEPT

Example embodiments generally relate to a user terminal for detecting forgery of an application program based on a hash value and a method of detecting forgery of an application program using the user terminal, and more particularly relate to a user terminal that is able to detect whether an application program installed on the user terminal is tampered on a platform level and a method of detecting forgery of an application program using the user terminal.

### BACKGROUND OF THE INVENTIVE CONCEPT

Although many people use a smart phone banking, a security of the smart phone banking is not strong. The smart phone is vulnerable to an attack since the smart phone is connected to an internet, which is a public network. Information stored in the smart phone may be leaked through the internet by a hacker and the smart phone may be exposed to an attack by a malicious code or a phishing. In addition, financial information of a user may be leaked by a tampered banking application.

Game applications and social network service (SNS) applications are also vulnerable to an attack as well as financial applications supporting a smart phone banking. Actually, personal information was leaked by the Trojan horse virus inserted in a tampered application of a game application, and a tampered application of an SNS application illegally charged to a user.

Researches have been developed to prevent an application tampering and to secure an integrity of an application. Most of the researches are related to technologies for decreasing a possibility of a reverse engineering and an application tampering using a code obfuscation and an anti-debugging.

However, conventional tamper detection technologies using a tamper detection code on an application program level is vulnerable to an attack since an attacker can analyze a structure of the application using the tamper detection code. For example, if an attacker extracts a Dalvik bytecode executed on a Dalvik virtual machine of an Android mobile system, the attacker can analyze a structure of an application. That is, tamper detection technologies on an application program level may be evaded by an attacker. Therefore, tamper detection technologies on a platform level are required.

The background art of the present invention has been described in Korean Patent Registration No. 10-1256462 (Apr. 19, 2013).

### CONTENTS OF THE INVENTIVE CONCEPT

### Technical Object of the Inventive Concept

Some example embodiments of the inventive concept generally provide a user terminal for detecting forgery of an application program based on a hash value and a method of detecting forgery of an application program using the user terminal, and more particularly provide a user terminal that is able to detect whether an application program installed on the user terminal is tampered on a platform level and a method of detecting forgery of an application program using the user terminal.

### Means for Achieving the Technical Object

According to example embodiments, a user terminal for detecting forgery of an application program based on a hash value includes a communication circuit, a hash value generation circuit and a forgery determination circuit. When the installed application program is executed, the communication circuit transmits information of the user terminal and information of the application program to an authentication server on a platform level to receive an original hash value of the application program from the authentication server, or to receive the original hash value of the application program from a peripheral device paired with the user terminal. The hash value generation circuit generates the hash value of the application program installed on the user terminal on the platform level. The forgery determination circuit compares the original hash value of the application program received from the authentication server or the peripheral device with the generated hash value of the application program on the platform level to determine whether the application program is tampered.

In some example embodiments, when the application program is installed on the user terminal and when the user terminal is paired with the peripheral device, the communication circuit may receive the original hash value of the application program from the authentication server to transfer the original hash value of the application program to the peripheral device.

In some example embodiments, when it is determined that the application program is tampered, the forgery determination circuit may terminate an execution of the application program. When it is determined that the application program is not tampered, the forgery determination circuit may execute the application program.

In some example embodiments, when it is determined that the application program is tampered, the forgery determination circuit may output an alert window to notify the forgery of the application program.

In some example embodiments, the hash value generation circuit may apply a hashing scheme to an execution code and a setting file of the application program or a whole of the application program to generate the hash value of the application program.

In some example embodiments, the user terminal may further include an encryption decryption circuit. The encryption decryption circuit may decrypt the original hash value of the application program received from the authentication server.

According to example embodiments, in a method of detecting forgery of an application program that is performed by a user terminal for detecting forgery of the application program based on a hash value, when the installed application program is executed, information of the user terminal and information of the application program are transmitted to an authentication server on a platform level to receive an original hash value of the application program from the authentication server, or to receive the original hash value of the application program from a peripheral device paired with the user terminal. The hash value of the application program installed on the user terminal is generated on the platform level. The original hash value of the application program received from the authentication server or the peripheral device is compared with the generated hash value of the application program on the platform level to determine whether the application program is tampered.

### Effects of the Inventive Concept

Accordingly, the user terminal may be protected from a tampered application program based on the present invention. In addition, since forgery of the application program is detected on the platform level, it may overcome limitations of tamper detection technologies on the application program level that can be evaded by an attacker.

In addition, when the original hash value required for detecting forgery of the application program is stored in the peripheral device paired with the user terminal, the user terminal may receive the original hash value from the peripheral device to detect forgery of the application program based on the received original hash value, even if the user terminal is in a poor internet connection.

### BRIEF DESCRIPTION OF THE DRAWINGS

FIG. 1 is a diagram illustrating a system for detecting forgery of an application program according to example embodiments.

FIG. 2 is a block diagram illustrating an authentication server according to example embodiments.

FIG. 3 is a block diagram illustrating a user terminal according to example embodiments.

FIG. 4 is a block diagram illustrating a peripheral device according to example embodiments.

FIG. 5 is a flow chart illustrating a method of detecting forgery of an application program according to a first embodiment.

FIG. 6 is a flow chart illustrating a method of detecting forgery of an application program according to a second embodiment.

FIG. 7 is a diagram for describing the method of detecting forgery of the application program according to the second embodiment.

### PARTICULAR CONTENTS FOR IMPLEMENTING THE INVENTIVE CONCEPT

Various example embodiments will be described more fully with reference to the accompanying drawings, in which some example embodiments are shown. The present inventive concept may, however, be embodied in many different forms and should not be construed as limited to the embodiments set forth herein. Rather, these embodiments are provided so that this disclosure will be thorough and complete, and will fully convey the scope of the present inventive concept to those skilled in the art. Like reference numerals refer to like elements throughout this application.

Hereinafter, various example embodiments will be described fully with reference to the accompanying drawings.

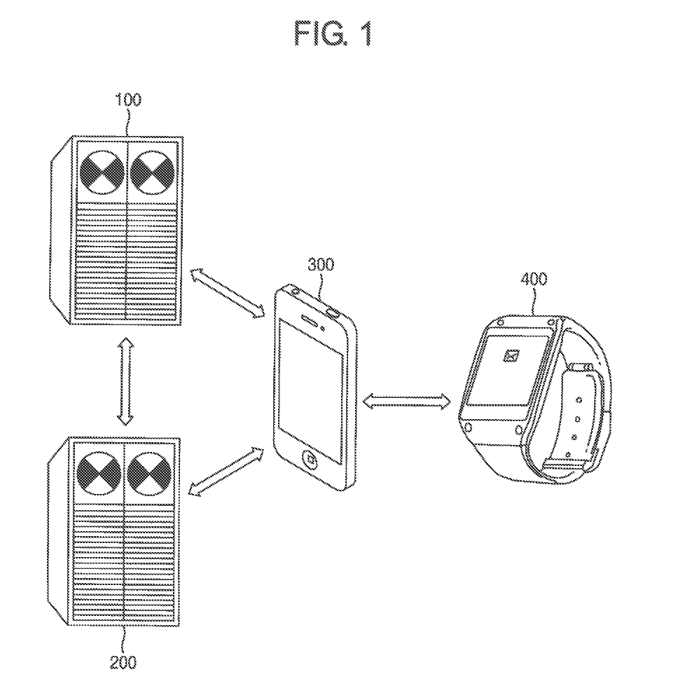

FIG. 1 is a diagram illustrating a system for detecting forgery of an application program according to example embodiments. Referring to FIG. 1, a system for detecting forgery of an application program (or a system for detecting an application program tampering) according to example embodiments includes an application program provision server 100, an authentication server 200 and a user terminal 300. The system may further include a peripheral device 400.

As illustrated in FIG. 1, the application program provision server 100, the authentication server 200, the user terminal 300 and the peripheral device 400 are connected with each other via networks. In other words, shown as FIG. 1, the user terminal 300 may he connected with the application program provision server 100, the authentication server 200 and the peripheral device 400 via networks. In addition, the application program provision server 100 may be connected with the authentication server 200 via a network.

Here, a network represents a configuration that is able to allow nodes such as user terminals and servers to exchange information with one another. In some example embodiments, the network may include, but are not limited to, Internet, Local Area Network (LAN), Wireless Local Area Network (Wireless LAN), Wide Area Network (WAN), Personal Area Network (PAN), Third-Generation (3D) Telecommunication Network, Fourth-Generation (4D) Telecommunication Network, Long-Term Evolution (LTE) Telecommunication Network, Wi-Fi network, etc.

In some example embodiments, the user terminal 300 may be connected with the peripheral device 400 based on Bluetooth, ZigBee, Infrared Data Association (IrDA), etc.

The application program provision server 100 stores an application program file (or an application package file), and transmits the application program file to the user terminal 300 when the application program provision server 100 receives a request for the application program file from the user terminal 300. In other words, the user terminal 300 may download the application program file stored in the application program provision server 100, may install an application program corresponding to the downloaded application program file, and may execute the installed application program.

The application program provision server 100 according to example embodiments may store various application program files corresponding to various types of application programs such as financial applications, news applications, shopping applications, game applications, etc., such that the user terminal 300 downloads the application program files from the application program provision server 100 and installs application programs corresponding to the downloaded application program files. For example, the application program provision server 100 may correspond to one of various types of mobile application markets such as Google Play, App Store of Apple, etc.

The application program provision server 100 applies a hashing scheme to an execution code and a setting file of the application program or the whole of the application program to generate a hash value of the application program. The application program provision server 100 stores the generated hash value. The hash value generated by the application program provision server 100 is an original hash value of the application program.

The application program provision server 100 transmits the original hash value of the application program to the authentication server 200.

The authentication server 200 receives the original hash value of the application program from the application program provision server 100 via the network to store the received original hash value. The authentication server 200 receives information of the user terminal 300 and information of the application program which needs to check whether forgery (or tampering) thereof from the user terminal 300 via the network, and transmits the original hash value of the application program to the user terminal 300.

In some example embodiments, the authentication server 200 may not receive the original hash value of the application program from the application program provision server 100. Instead, the authentication server 200 may receive the application program file from the application program provision server 100, may apply the hashing scheme to the execution code and the setting file of the application program or the whole of the application program to generate itself the hash value of the application program, and may store the generated original hash value.

The user terminal 300 transfers the original hash value of the application program that is received from the authentication server 200 to the peripheral device 400 that is paired with the user terminal 300. When the application program is executed, the user terminal 300 receives the original hash value of the application program from the authentication server 200 or the peripheral device 400, and compares the received original hash value with hash value that is generated by the user terminal 300 to determine whether the application program has been tampered (or forged).

In some example embodiments, the user terminal 300 may include any terminals on which the application program is installed and executed, such as a smart phone, a smart pad, a cellular phone, a laptop computer, a tablet computer, a personal digital assistant (PDA), etc. In case of the smart phone and the smart pad, the application program may be provided as an application.

Here, the application program or the application represents any codes, instructions, program routines and/or software programs which are installed and executed on the user terminal 300. For example, the application may include an App that is executable on a mobile device. A user may download the App from a mobile application market, which corresponds to a virtual market for trading mobile contents, to install the App on the user terminal 300 such as the a smart phone. The mobile application market may correspond to the application program provision server 100.

In some example embodiments, the user terminal 300 may install the application program based on one of various application program files that is downloaded from the application program provision server 100 to execute the installed application program, or may execute one of various application programs that is already installed on the user terminal 300.

The peripheral device 400 receives the original hash value of the application program from the user terminal 300 to store the received original hash value. When the peripheral device 400 receives an execution notification message from the user terminal 300, the peripheral device 400 transmits an original message that includes the original hash value of the application program requested based on the execution notification message to the user terminal 300.

In some example embodiments, the peripheral device 400 may include any electronic devices which are able to communicate with the user terminal 300 and to store the original hash value of the application program. For example, the peripheral device 400 may include any wearable devices such as a smart watch, smart glasses, a smart band, etc., and/or may include any devices such as an external hard disk drive (HDD), a USB storage, a USB on-the-go (OTG), etc. that are able to communicate with the user terminal 300.

In some example embodiments, any Appcessory such as an activity tracker, a mobile photo printer, a home monitoring device, a plaything, a medical device, etc. may be provided as the peripheral device 400. Here, the Appcessory represents an accessory which is interoperable with the user terminal 300 such as the smart phone to increase functionality of the smart phone.

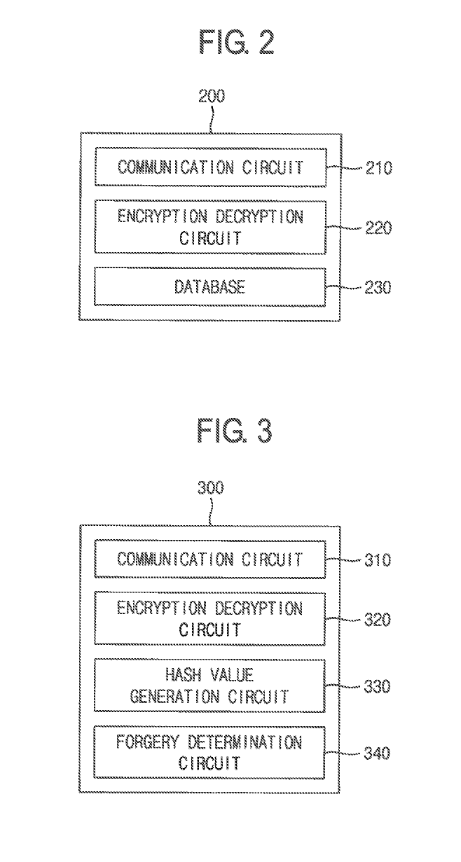

FIG. 2 is a block diagram illustrating an authentication server according to example embodiments.

Referring to FIG. 2, an authentication server 200 includes a communication circuit 210, an encryption decryption circuit 220 and a database 230.

The communication circuit 210 receives an execution notification message from the user terminal 300, and transmits an original message to the user terminal 300. The execution notification message includes information of the user terminal 300 and information of an application program which needs to check whether forgery (or tampering) thereof (e.g., whether the application program has been tampered). After the execution notification message is received, the authentication server 200 transmits the original message including the original hash value of the application program to the user terminal 300 in response to the reception of the execution notification message.

In some example embodiments, when the system for detecting the forgery of the application program includes the peripheral device 400, the authentication server 200 may receive a request message from the user terminal 300, and may transmit a response message to the user terminal 300.

Similar to the execution notification message, the request message may include the information of the application program which needs to check whether the forgery thereof. Similar to the original message, the response message may include the original hash value of the application program.

The encryption decryption circuit 220 encrypts the original message that is to be transmitted to the user terminal 300. When the user terminal 300 encrypts the execution notification message and transmits the encrypted execution notification message to the authentication server 200, the encryption decryption circuit 220 may decrypt the received execution notification message.

In some example embodiments, when the system for detecting the forgery of the application program includes the peripheral device 400, the encryption decryption circuit 220 may decrypt the request message received from the user terminal 300, and may encrypt the response message that is to be transmitted to the user terminal 300.

The database 230 stores the original hash value of the application program. For example, the database 230 may store a plurality of original hash values for a plurality of the application programs. When the plurality of original hash values are stored in the database 230, the communication circuit 210 may transmit the original hash value that corresponds to the information of the application program included in the received request message or the received execution notification message to the user terminal 300.

In some example embodiments, the original hash value may be received from the application program provision server 100, or may be generated, by the authentication server 200, based on the application program file that is received from the application program provision server 100.

In some example embodiments, when the authentication server 200 generates itself the original hash value, the database 230 may further store the application program file received from the application program provision server 100.

FIG. 3 is a block diagram illustrating a user terminal according to example embodiments.

Referring to FIG. 3, a user terminal 300 according to example embodiments includes a communication circuit 310, an encryption decryption circuit 320, a hash value generation circuit 330 and a forgery determination circuit 340.

The user terminal 300 communicates with the authentication server 200 by the communication circuit 310. The communication circuit 310 transmits the execution notification message that includes the information of the user terminal 300 and the information of the application program which needs to check whether the forgery thereof to the authentication server 200.

The application program which needs to check whether the forgery thereof may be an application program that is to be executed by a user. When the application program is executed, the communication circuit 310 may transmit the execution notification message to the authentication server 200. The communication circuit 310 receives the original message including the original hash value of the application program from the authentication server 200.

In some example embodiments, when the system for detecting the forgery of the application program includes the peripheral device 400, the user terminal 300 may also communicate with the peripheral device 400 by the communication circuit 310. When the user terminal 300 is paired with the peripheral device 400 (e.g., when pairing is performed between the user terminal 300 and the peripheral device 400), the communication circuit 310 may transmit the original hash value of the application program received from the authentication server 200 to the peripheral device 400. When the application program is executed, the communication circuit 310 may transmit the execution notification message to the peripheral device 400, and may receive the original message including the original hash value of the application program from the peripheral device 400.

The encryption decryption circuit 320 decrypts the original message that is received from the authentication server 200 via the communication circuit 310. The encryption decryption circuit 320 may encrypt the execution notification message that is to be transmitted to the authentication server 200. When the user terminal 300 transmits the response message that is received from the authentication server 200 to the peripheral device 400 without decrypting the response message, the encryption decryption circuit 320 may decrypt the original message that is received from the peripheral device 400 to obtain the original hash value of the application program while the application program is executed.

When the application program is installed on the user terminal 300 based on the application program file that is downloaded from the application program provision server 100, or when the installed application program is executed, the hash value generation circuit 330 generates a hash value of the application program. The hash value generation circuit 330 stores the generated hash value.

The forgery determination circuit 340 loads the generated hash value to compare the generated hash value with the original hash value that is received from the authentication server 200. For example, an operation mode of the user terminal 300 may be converted into an examination mode, and then the comparison of the hash value may be performed in the examination mode.

The forgery determination circuit 340 determines whether the application program has been tampered based on a result of the comparison of the hash value, and determines whether the application program is executed (e.g., whether the execution of the application program is maintained or terminated) based on a result of the determination.

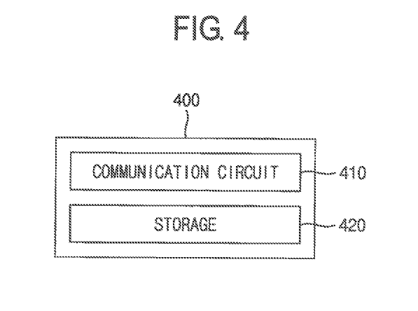

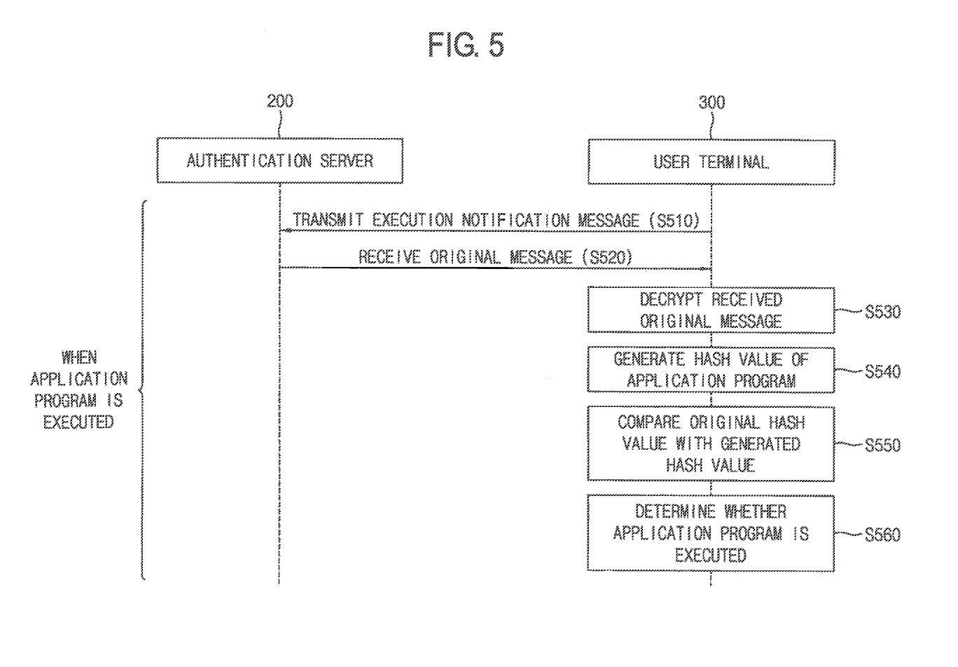

The system for detecting the forgery of the application program may further include a peripheral device. FIG. 4 is a block diagram illustrating a peripheral device according to example embodiments.

Referring to FIG. 4, a peripheral device 400 may include a communication circuit 410 and a storage 420. The communication circuit 410 may communicate with the user terminal 300. When the peripheral device 400 is paired with the user terminal 300 based on a wired network or a wireless network, the communication circuit 410 may receive the original hash value of the application program from the user terminal 300. When the application program installed on the user terminal 300 is executed, the communication circuit 410 may receive the execution notification message from the user terminal 300, and may transmit the original message to the user terminal 300.

The storage 420 may store the original hash value of the application program that is received by the communication circuit 410.

The storage 420 may store a plurality of original hash values for a plurality of the application programs. When the plurality of original hash values are stored in the storage 420, the communication circuit 410 may transmit the original hash value that corresponds to the information of the application program included in the received execution notification message to the user terminal 300.

Hereinafter, a method of detecting forgery of an application program based on a hash value according to example embodiments will be described in detail with reference to FIGS. 5 through 7.

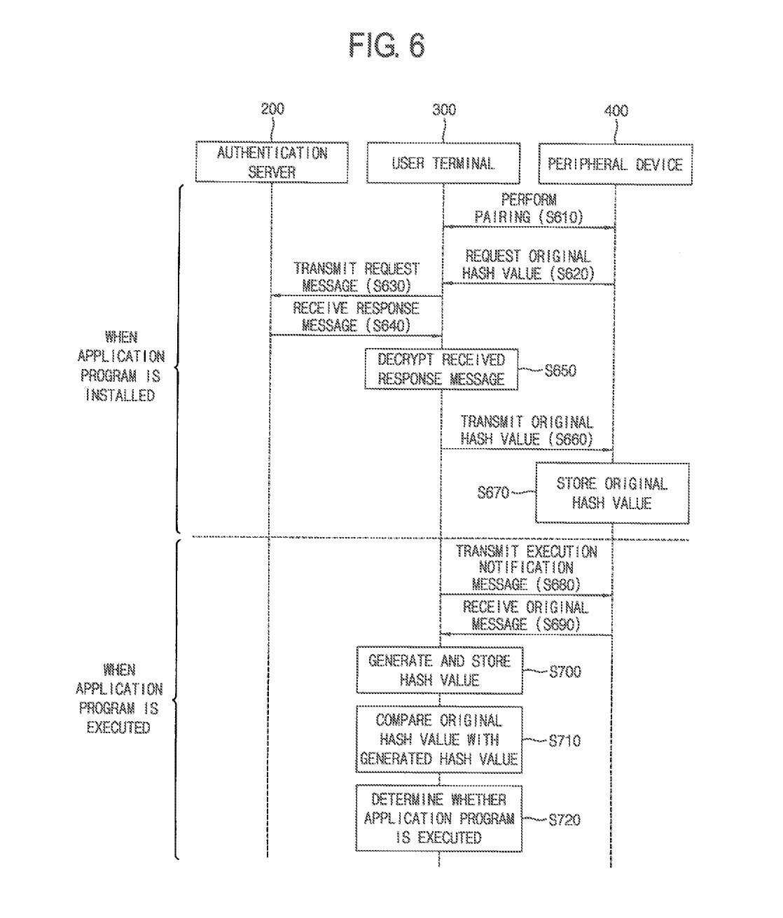

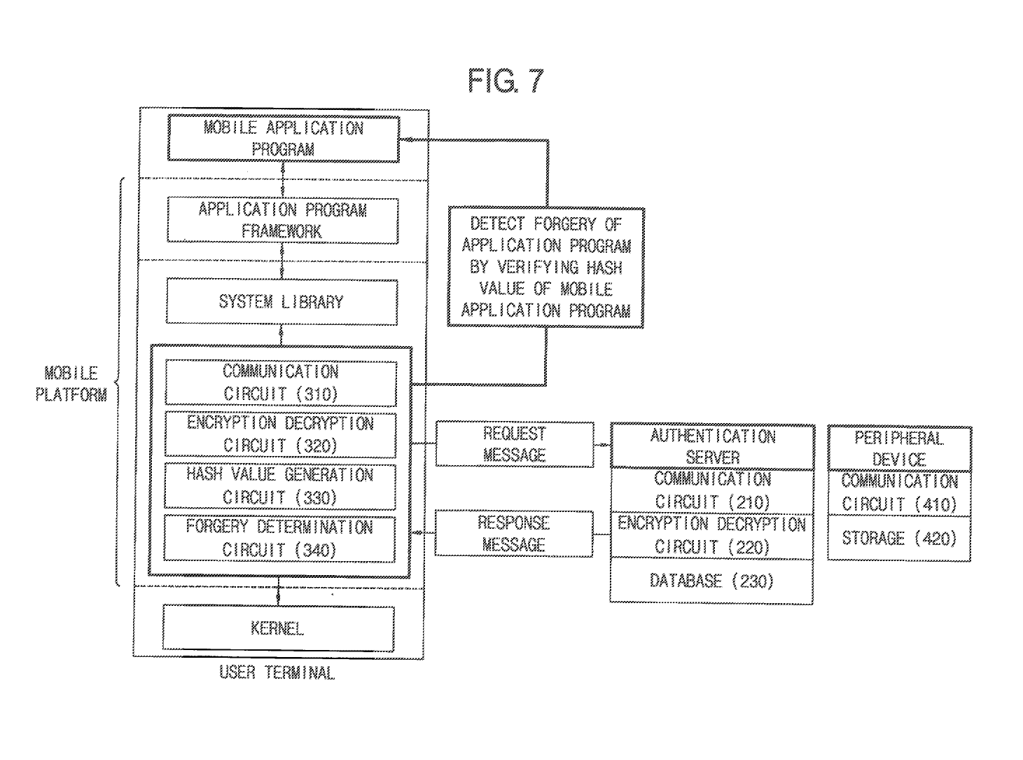

FIG. 5 is a diagram for describing a first embodiment of the present invention, and illustrates a technique of detecting forgery of an application program based on an original hash value received from an authentication server without a peripheral device. FIGS. 6 and 7 are diagrams for describing a second embodiment of the present invention, and illustrate a technique of detecting forgery of an application program based on an original hash value received from a peripheral device.

FIG. 5 is a flow chart illustrating a method of detecting forgery of an application program according to a first embodiment.

Referring to FIG. 5, when for while) an application program installed on the user terminal 300 is executed, the user terminal 300 transmits an execution notification message to the authentication server 200 (step S510). The execution notification message includes information of the user terminal 300 and information of the application program which is to be executed by a user and needs to check whether forgery thereof. To request an original hash value of the application program which is required for detecting whether forgery thereof, the user terminal 300 transmits the execution notification message to the authentication server 200 on a platform level.

In some example embodiments, the authentication server 200 may receive the original hash value of the application program from the application program provision server 100, and may store the original hash value. Alternatively, the authentication server 200 may not receive the original hash value from the application program provision server 100, may generate itself the original hash value of the application program based on an application program file that corresponds to the application program and is received from the application program provision server 1.00 by applying a hashing scheme to an execution code and a setting file of the application program or the whole of the application program, and may store the original hash value.

The user terminal 300 receives an original message from the authentication server 200 on the platform level (step S520). The original message includes the original hash value of the application program that is requested in the step S510 and is requested by the user terminal 300 based on the execution notification message.

When the authentication server 200 transmits an encrypted original message to the user terminal 300, the user terminal 300 decrypts the received original message (step S530). The user terminal 300 decrypts the original message to obtain the original hash value of the application program.

Here, a hash value (or a hash code, a hash sum, or simply a hash) represents a result generated by a hash function or a hash algorithm where a type of short electronic fingerprint is obtained from any data.

A hash function represents any function which can be used to map a string of arbitrary length into a binary string of fixed length (or to map data of arbitrary size into data of fixed sire). A hash value is generated based on the hash function e.g., by cutting (or truncating) data, by transposing data or by shifting a location of data. For example, the hash function may include Secure Hash Algorithm (SHA), Hash Algorithm Standard 160 (HAS-160), etc.

If two hash values generated by the same hash function or the same hash algorithm are different from each other, two original data corresponding to the two hash values are also different from each other. By such characteristic, a hash value may be used for verifying integrity of data, certification, non-repudiation, etc. For example, a downloaded file may be verified based on a hash value, it may be determined based on a hash value whether original data is tampered (or forged) in a digital signature, and/or a hash value may be used for cryptography.

The user terminal 300 generates a hash value of the application program installed on the user terminal 100 on the platform level (step S540).

The user terminal 300 may apply the hashing scheme to the execution code and the setting file of the application program or the whole of the application program to generate the hash value of the application program, and may store the generated hash value. The hash value that is generated by and stored in the user terminal 300 may be loaded in step S550 and used for detecting whether the application program is tampered (or forged).

The user terminal 300 loads the generated hash value to compare the original hash value that is received from the authentication server 200 with the generated hash value on the platform level (step S550). For example, an operation mode of the user terminal 300 may be converted into an examination mode, and then the comparison of the hash value may be performed in the examination mode.

The user terminal 300 determines whether the application program is executed based on a result of the comparison of the hash value (step S560).

When the original hash value is substantially the same as the generated hash value based on the result of the comparison of the hash value in the step S550, it is determined that the application program is not tampered, and then the user terminal 300 normally executes the application program (e.g., an execution of the application program is maintained). For example, an operation mode of the user terminal 300 may be converted into an execution mode, and then the application program may be executed in the execution mode.

When the original hash value is different from the generated hash value, it is determined that the application program is tampered, and then the user terminal 300 terminates the execution of the application program.

When it is determined that the application program is tampered, the user terminal 300 may output or display an alert window to notify the forgery of the application program such that the forgery of the application program is recognized by a user. In addition, the user terminal 300 may transmit a message for notifying a spread of a tampered application program to the application program provision server 100 or the authentication server 200.

Hereinafter, based on an example where a method of detecting forgery of an application program according to example embodiments includes the peripheral device 400, a method of detecting forgery of an application program based on a hash value will be described in detail with reference to FIGS. 6 and 7.

FIG. 6 is a flow chart illustrating a method of detecting forgery of an application program according to a second embodiment. FIG. 7 is a diagram for describing the method of detecting forgery of the application program according to the second embodiment.

Referring to FIGS. 6 and 7, when (or while) an application program is installed on the user terminal 300, and when there is the peripheral device 400 adjacent to the user terminal 300, pairing is performed between the user terminal 300 and the peripheral device 400 (step S610).

Pairing represents a connection between two electronic devices based on a wired network or a wireless network. In the method of detecting the forgery of the application program according to example embodiments, the user terminal 300 is paired with the peripheral device 400. As will be described with reference to step S660, after the user terminal 300 is paired with the peripheral device 400, the user terminal 300 may transmit an original hash value of the application program to the peripheral device 400.

When (or while) the pairing is performed, the user terminal 300 may transmit a message for searching peripheral electronic devices to the peripheral device 400, and the peripheral device 400 may transmit a message including information of the peripheral device 400 to the user terminal 300. The user terminal 300 may transmit information or the user terminal 300 and information of the application program corresponding to the original hash value to the peripheral device 400. The information of the user terminal 300 and the information of the application program may be received by and registered on the peripheral device 400.

When the pairing between the user terminal 300 and the peripheral device 400 is successfully completed, the peripheral device 400 requests the original hash value of the application program that is to be stores in the peripheral device 400 to the user terminal 300 (step S620).

The user terminal 300 transmits a request message fur requesting the original hash value to the authentication server 200 (step S630).

The step S630 of transmitting the request message from the user terminal 300 to the authentication server 200 may be substantially the same as the step S510 (of FIG. 5) of transmitting the execution notification message from the user terminal 300 to the authentication server 200, and thus a duplicated explanation will be omitted.

The user terminal 300 receives a response message from the authentication server 200 (step S640). The response message in the step S640 may be substantially the same as the original message that is received from the authentication surer 200 in the step S520 of FIG. 5, and thus a duplicated explanation will be omitted.

The user terminal 300 decrypts the received response message (step S650). The step S650 of decrypting the received response message by the user terminal 300 to obtain the original hash value may be substantially the same as the step S530 (of FIG. 5) of decrypting the received original message by the user terminal 300, and thus a duplicated explanation will be omitted.

The user terminal 300 transmits the original hash value to the peripheral device 400 (step S660), and the peripheral device 400 stores the received original hash value (step S670).

For convenience of explanation, the second embodiment is described based on an example where the user terminal 300 decrypts the response message received from the authentication server 200 in the step S650 and transmits the original hash value to the peripheral device 400 in the step S660, however, the second embodiment is not limited thereto. For example, the user terminal 300 may transmit the received response message to the peripheral device 400 without decryption, may receive an original message including the original hash value from the peripheral device 400 in step S690, and may decrypt the original message to obtain the original hash value.

In some example embodiments, when the application program that is already installed on the user terminal 300 is executed, the original hash value of the application program may be already stored in the peripheral device 400. In this example, the steps S610 through S670 may be omitted, and then the method of detecting the forgery of the application program may be started from step S680.

When (or while) the application program that is already installed on the user terminal 300 is executed, the user terminal 300 transmits an execution notification message to the peripheral device 400 that stores the original hash value of the application program on the platform level (step S680).

The execution notification message in the step S680 may be substantially the same as the execution notification message that is transmitted from the user terminal 300 to the authentication server 200 in the step S510 of FIG. 5, and thus a duplicated explanation will be omitted.

The user terminal 300 receives the original message including the original hash value of the application program from the peripheral device 400 on the platform level (step S690).

The original message in the step S690 may be substantially the same as the original message that is received in the step S520 of FIG. 5, and thus a duplicated explanation will be omitted.

The user terminal 300 generates a hash value of the application program installed on the user terminal 300 on the platform level to store the generated hash value (step S700).

The user terminal 300 loads the hash value that is generated by and stored in the user terminal 300 in the step S700, and compares the original hash value that is received from the peripheral device 400 with the generated hash value on the platform level (step S710). For example, an operation mode of the user terminal 300 may be converted into an examination mode, and then the comparison of the hash value may be performed in the examination mode.

The user terminal 300 determines whether the application program is executed based on a result of the comparison of the hash value in the step S710 (step S720). The step S720 of determining the forgery of the application program to determine whether an execution of the application program may be substantially the same as the step S560 of FIG. 5, and thus a duplicated explanation will be omitted.

As such, the user terminal may be protected from a tampered application program based on the present invention. In addition, since the forgery of the application program is detected on the platform level, it may overcome limitations of tamper detection technologies on the application program level that can be evaded by an attacker.

In addition, when the original hash value required for detecting the forgery of the application program is stored in the peripheral device paired with the user terminal, the user terminal may receive the original bash value from the peripheral device to detect the forgery of the application program based on the received original hash value, even if the user terminal is in a poor internet connection.

The foregoing is illustrative of example embodiments and is not to be construed as limiting thereof. Although a few example embodiments have been described, those skilled in the art will readily appreciate that many modifications are possible in the example embodiments without materially departing from the novel teachings and advantages of the present inventive concept. Accordingly, all such modifications are intended to be included within the scope of the present inventive concept as defined in the claims. Therefore, it is to be understood that the foregoing is illustrative of various example embodiments and is not to be construed as limited to the specific example embodiments disclosed, and that modifications to the disclosed example embodiments, as well as other example embodiments, are intended to be included within the scope of the appended claims.

### REFERENCE NUMERALS

100: application program provision server

200: authentication server

210: communication circuit

220: encryption decryption circuit

230: database

300: user terminal

310: communication circuit

320: encryption decryption circuit

330: hash value generation circuit

340: forgery determination circuit

400: peripheral device

410: communication circuit

420: storage

What is claimed is:

1. A user terminal for detecting forgery of an application program installed on the user terminal, the user terminal comprising:
a communication circuit configured to, when the installed application program is executed, transmit information of the user terminal and information of the application program to an authentication server on a platform level to receive an original hash value of the application program from the authentication server, or to receive the original hash value of the application program from a peripheral device paired with the user terminal;
a hash value generation circuit configured to generate a hash value of the application program installed on the user terminal on the platform level; and
a forgery determination circuit configured to compare the original hash value of the application program received from the authentication server or the peripheral device with the generated hash value of the application program on the platform level to determine whether the application program is tampered.

2. The user terminal of claim 1, wherein when the application program is installed on the user terminal and when the user terminal is paired with the peripheral device, the communication circuit receives the original hash value of the application program from the authentication server to transfer the original hash value of the application program to the peripheral device.

3. The user terminal of claim 1, wherein when it is determined that the application program is tampered, the forgery determination circuit terminates an execution of the application program,
wherein when it is determined that the application program is not tampered, the forgery determination circuit executes the application program.

4. The user terminal of claim 1, wherein when it is determined that the application program is tampered, the forgery determination circuit outputs an alert window to notify the forgery of the application program.

5. The user terminal of claim 1, wherein the hash value generation circuit applies a hashing scheme to an execution code and a setting file of the application program or a whole of the application program to generate the hash value of the application program.

6. The user terminal of claim 1, farther comprising:
an encryption decryption circuit configured to decrypt the original hash value of the application program received from the authentication server.

7. A method of detecting forgery of an application program installed on a user terminal, the method comprising:
when the installed application program is executed, transmitting information of the user terminal and information of the application program to an authentication server on a platform level to receive an original hash value of the application program from the authentication server, or to receive the original hash value of the application program from a peripheral device paired with the user terminal;
generating a hash value of the application program installed on the user terminal on the platform level; and
comparing the original hash value of the application program received from the authentication server or the peripheral device with the generated hash value of the application program on the platform level to determine whether the application program is tampered.

8. The method of claim 7, further comprising:
when the application program is installed on the user terminal and when the user terminal is paired with the peripheral device, receiving the original hash value of the application program from the authentication server to transfer the original hash value of the application program to the peripheral device.

9. The method of claim 7, wherein when it is determined that the application program is tampered, an execution of the application program is terminated,
wherein when it is determined that the application program is not tampered, the application program is executed.

10. The method of claim 7, wherein when it is determined that the application program is tampered, an alert window is output to notify the forgery of the application program.

11. The method of claim 7, wherein generating the hash value of the application program includes:
applying a hashing scheme to an execution code and a setting file of the application program or a whole of the application program to generate the hash value of the application program.

12. The method of claim 7, further comprising:
decrypting the original bash value of the application program received from the authentication server.
